(19) United States
(12) Patent Application Publication
(10) Pub. No.: US 2017/0024104 A1
(43) Pub. Date: Jan. 26, 2017

(54) ERASURE GESTURE

(71) Applicant: SuccessFactors, Inc., San Francisco, CA (US)

(72) Inventor: Thomas Angermayer, Stetten (DE)

(21) Appl. No.: 14/808,950

(22) Filed: Jul. 24, 2015

(51) Int. Cl. G06F 3/0488

(52) U.S. Cl. CPC G06F 3/0488

(57) ABSTRACT

Methods and apparatus, including computer program products, are provided for gesture detection on a user interface such as a touchscreen. In one aspect there is provided a method. The method may include detecting a touch on an entry presented on a touchscreen as a candidate erasure figure gesture; tracking a finger motion associated with the detected touch to determine whether the finger motion corresponds to an erasure figure gesture; and sending a message to cancel the entry, when the finger motion corresponds to the erasure figure gesture. Related systems and articles of manufacture are also discloses.

### FIELD

The present disclosure generally relates to finger gestures.

### BACKGROUND

Touch-based devices have become increasingly important for computer-based devices. For example, smart phones, tablets, and other devices often include touch sensitive user interfaces to allow a user to make selections via touch. Although touch-based devices may allow a user to touch a user interface to interact with the device, gestures used to interact with the device may not be intuitive or may be difficult for some users to gesture, making it more difficult for the users to interact with the device via touch.

### SUMMARY

Methods and apparatus, including computer program products, are provided for gesture detection on a user interface such as a touchscreen.

In one aspect there is provided a method. The method may include detecting a touch on an entry presented on a touchscreen as a candidate erasure figure gesture; tracking a finger motion associated with the detected touch to determine whether the finger motion corresponds to an erasure figure gesture; and sending a message to cancel the entry, when the finger motion corresponds to the erasure figure gesture.

In some implementations, the above-noted aspects may further include additional features described herein including one or more of the following. When the finger motion corresponds to a back and forth movement along the touchscreen, the finger gesture is determined to be the erasure figure gesture. The back and forth movement may be over the same axis. The back and forth movement may be over the same area. The back and forth movement may be over substantially the same area and/or axis. The back and forth motion may be predefined with respect to an initial direction. The initial direction may be right, left, horizontal, vertical, or a combination thereof. The back and forth motion may be predefined with respect to a quantity of back and forth movements. The quantity may include 1½ back and forth movements. The quantity may include at least one 2, 3, or 4 back and forth movements. The message may be sent, when the finger gesture remains within a region on the touchscreen associated with the entry. The entry may be at least a date on a planner.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

In the drawings,

FIG. 1A depicts an example of a page presented at a touchscreen;

FIG. 1B depicts an example of the page presented at the touchscreen including an example of an erasure figure gesture to cancel an entry;

FIGS. 2A-2G depict examples of erasure figure gestures;

FIG. 3 depicts an example of a system for detecting an erasure figure gesture; and

FIG. 4 depicts an example of a process for detecting an erasure figure gesture.

Like labels are used to refer to same or similar items in the drawings.

### DETAILED DESCRIPTION

Vacation calendars, personal shift schedule, production plans, and/or other types of graphically-based planners are increasingly becoming a part of business. These graphically-based planners can simplify the task of planning, which explains in part their popularity.

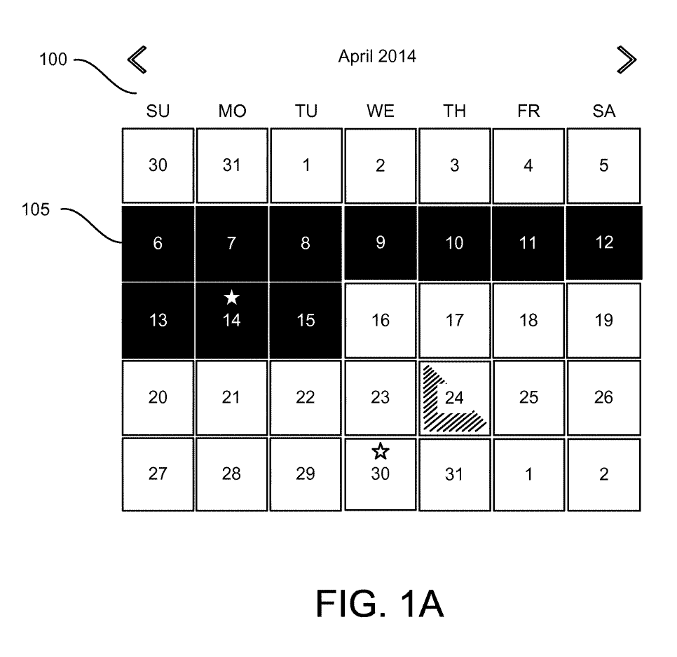

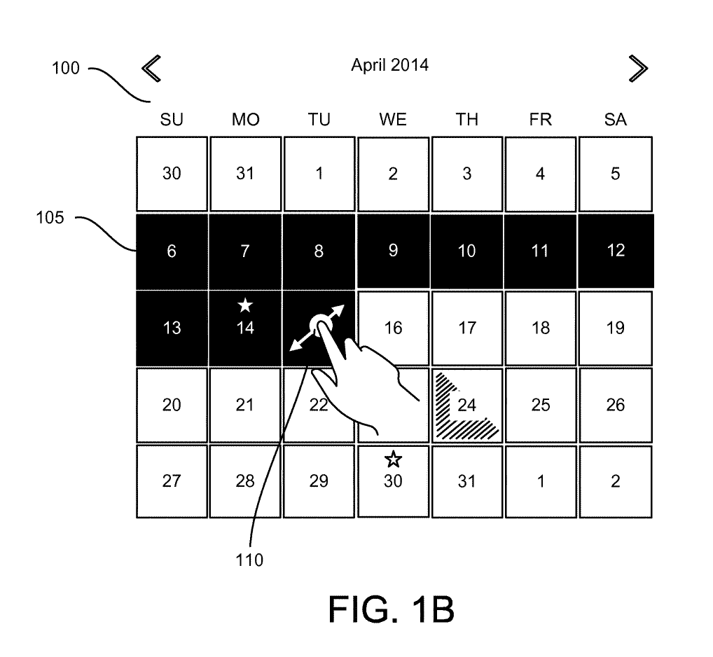

FIG. 1A depicts an example of a view or page of a graphically-based planner 100, such as a calendar, work force management planner, and/or the like, which can be presented on a touchscreen display at a computer, a smartphone, a tablet, and/or other type of data processor.

In the example of FIG. 1A, a user may select one or more days to request time off. This selection may generate a message, such as an email or the like, requesting vacation days from a supervisor, for example. In the example of FIG. 1A, the user may select 105 April 6-15, which can be used to generate a vacation request that can be sent to an approval entity, such as another data processor (associated with a supervisor, for example). However, once the selection of April 6-15 is made, it can be cumbersome to cancel a given day. For example, if a user wanted to cancel April 8 or 15 from the vacation selection, the user may be required to open a file, make edits to the file to delete the day to be canceled, and then save the change.

In some example implementations, there is provided a finger gesture to cancel an entry.

In some example implementations, the figure gesture comprises an erasure figure gesture on a touchscreen.

In some example implementations, the erasure figure gesture (also referred to herein as the erasure gesture) may be used to cancel an entry.

In some example implementations, the erasure figure gesture comprises a back and forth motion.

FIG. 1B depicts the graphically-based planner 100 of FIG. 1A. In the example of FIG. 1B, the user wants to cancel April 15 from the vacation selection 105 of April 6-15. To that end, the user may perform a figure gesture 110 comprising an erasure gesture, as shown. For example, the finger may make contact with a touchscreen presenting the planner 100. Specifically, the finger may make contact with for example an entry to be canceled. The figure may perform a figure gesture 110 comprising an erasure gesture to cancel the date entry of April 15. In this example, the figure erasure gesture represents a back and forth finger movement. This back and forth movement may be over the same, or substantially the same, axis along the touchscreen (as shown by the double lined arrow at 110). Regarding the substantially the same axis, a movement may be considered to be over the substantially the same axis if the movement is over a typical finger width (for example, if the back and forth along a given axis deviates by a typical finger width, then the movements are substantially along the same axis). This back and forth finger motion (which as noted is similar to a pencil erasure motion) may be detected by the touchscreen, and this detection may trigger the graphically-based planner 100 to cancel the vacation request for April 15 (which is the date associated with the erasure motion 110).

Although some of the examples refer herein to a calendar, the figure erasure gesture disclosed herein may be used with other graphically-based programs and planners as well.

Moreover, although the examples refer herein to a finger touch of a touchscreen, this finger touch may also include a stylus touch. For example, the finger erasure gesture may be performed with a stylus on the touchscreen as well.

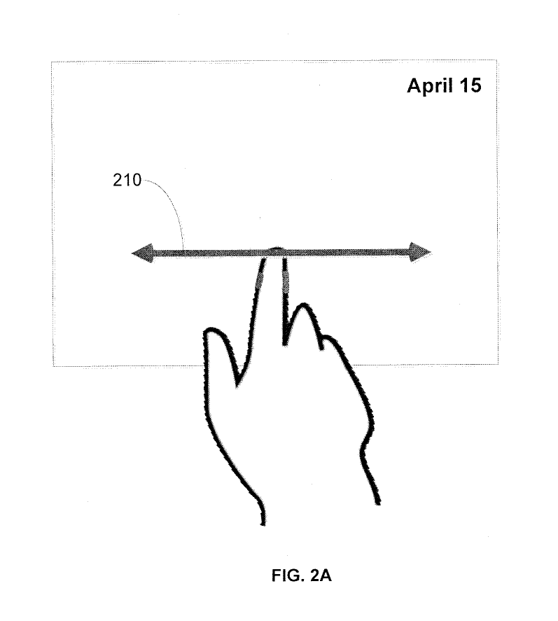

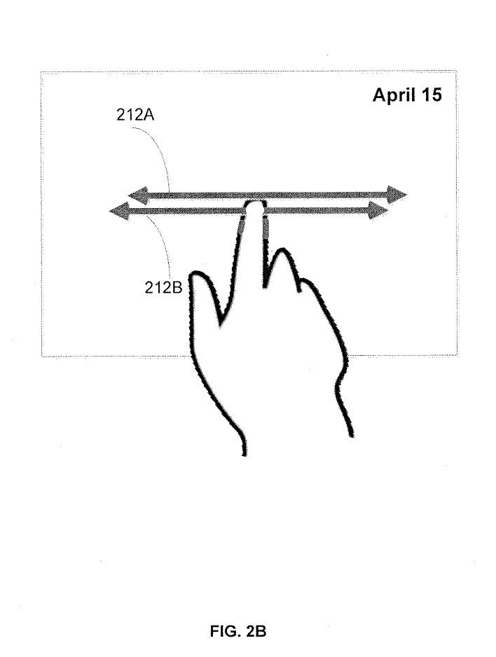

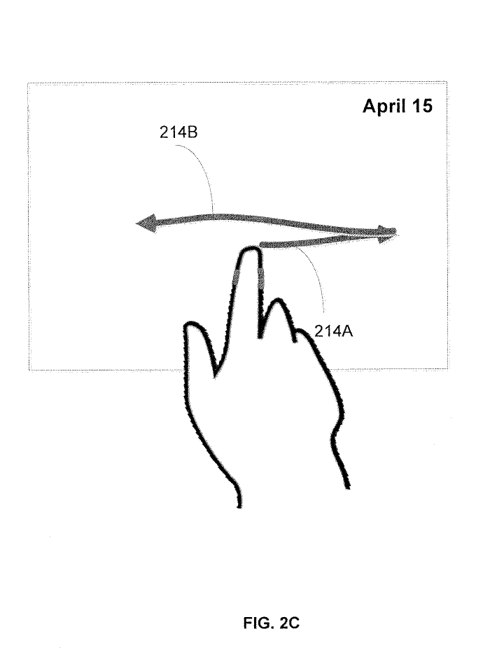

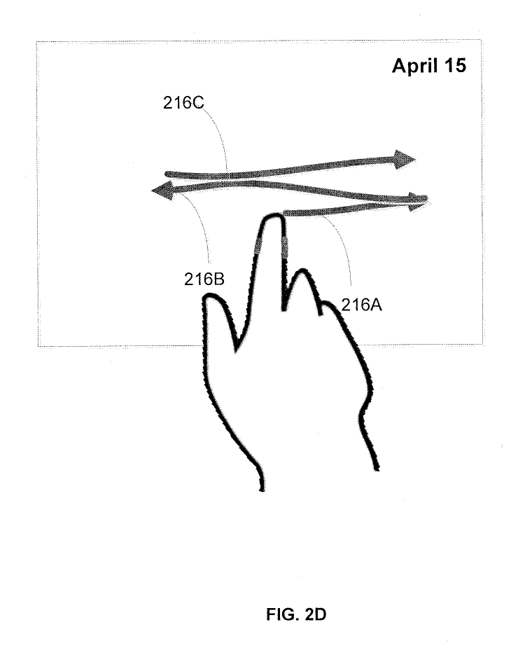

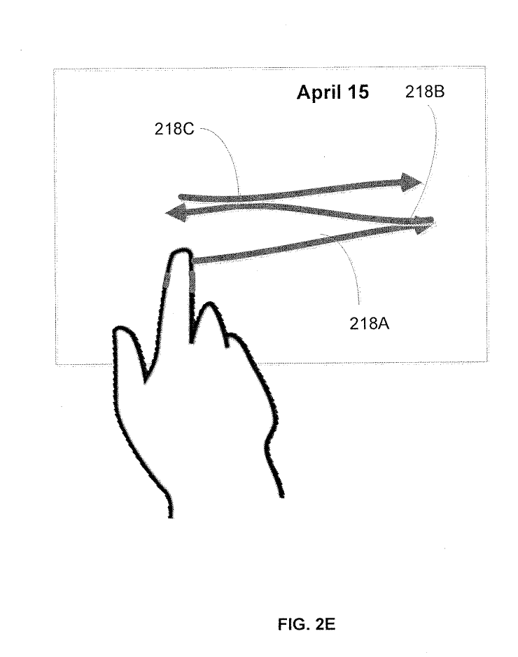

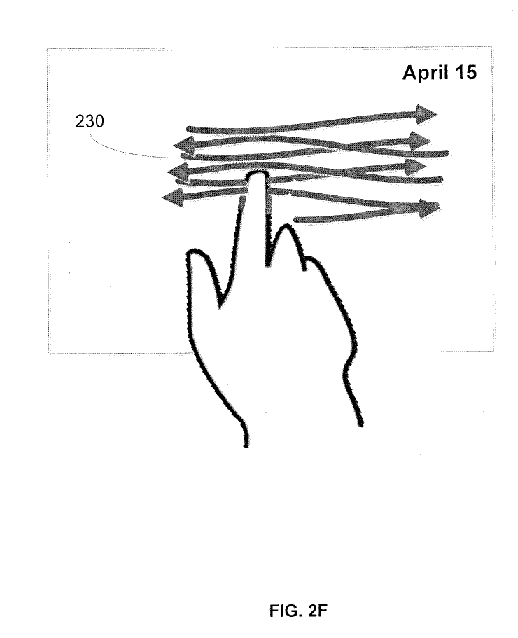

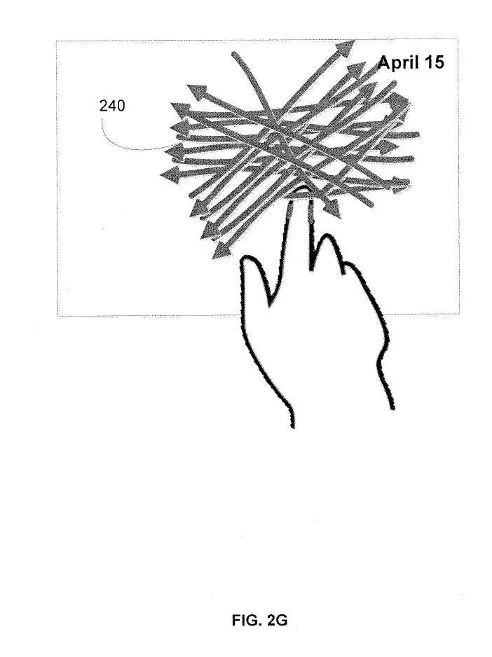

FIG. 2A depicts another example of erasure finger gesture, in accordance with some example implementations. In this example, the erasure finger gesture 210 is depicted by the arrow showing a back and forth finger movement over the same, or substantially the same, axis. For example, the finger may make contact with the touchscreen presenting the item to be canceled, such as April 15. The finger may then make a back and forth movement to the right and left one or more times. This back and forth finger motion may be detected by the touchscreen, and this detection may trigger the graphically-based planner 100 to cancel an entry, such as the vacation request for April 15 for example.

In some implementations, the back and forth motion may be predefined with respect to direction. For example, the initial back and forth motion may be defined to the right in order to be considered an erasure finger gesture.

In some implementations, the back and forth motion may be predefined with respect to a predetermined quantity of back and forth movements. For example, the back and forth motion may be defined to require 1½, 2, 3, or 4 for example, back and forth movements to be considered an erasure finger gesture. Moreover, the back and forth motion may be defined to have a predetermined direction. For example, the back and forth motion may be defined so that the initial motion is horizontal with respect to the touch screen, although other directions may be defined as well including vertical or a combination of horizontal and vertical.

FIG. 2B depicts another example of an erasure finger gesture, in accordance with some example implementations. In this example, the erasure finger gesture 212A-B is depicted by the arrows showing two back and forth finger movements 212A-B over substantially the same area. For example, the finger may make contact with the touchscreen in an area corresponding to the entry to be deleted, such as the April 15 entry noted above. The finger may then proceed to move to the right and then return back to the left over 212A and then make another move to the right and then return back to the left over 212B. Although this example refers to an initial movement to the right, this movement may be in other directions as well.

FIG. 2C depicts another example of an erasure finger gesture, in accordance with some example implementations. In this example, the erasure finger gesture 214A-B is depicted by the arrows showing back and forth finger movements 2124-B over an area associated an entry to be canceled. In this example, the finger may make contact with the touchscreen in an area corresponding to the entry to be deleted. The finger may then proceed to move to the right 214A and then return back to the left over 214B. Although this example refers to an initial movement to the right, this movement may be in other directions as well.

FIG. 2D depicts another example of erasure finger gesture, in accordance with some example implementations. In this example, the erasure finger gesture 216A-C is depicted by the arrows showing back and forth finger movements 216A-C over an area associated an entry to be canceled. For example, the finger may move to the right 216A and then return back to the left over 216B and then make another move to the right 216C. Although this example refers to an initial movement to the right, the movements may be in other directions as well.

FIG. 2E depicts another example of erasure finger gesture, in accordance with some example implementations. In this example, the erasure finger gesture 218A-C is depicted by the arrows showing back and forth finger movements 218A-C over an area associated an entry to be canceled. For example, the finger may move to the right 218A and then return back to the left over 218B and then make another move to the right 218C. Although this example refers to an initial movement to the right, the movements may be in other directions as well.

FIG. 2F depicts another example of erasure finger gesture, in accordance with some example implementations. In this example, the erasure finger gesture 230 is depicted by the arrows showing back and forth finger movements over an area associated an entry to be canceled. For example, the finger may move to the right and then return back to the left a plurality of times. In some example embodiments, the finger gesture may, as noted, require a predetermined quantity of back and forth movements in order to be classified as an erasure gesture. For example, the predetermined quantity of back and forth movements may be 1½, 2, 2½, 3, 3½, 4, 4½, 5, 5½, 6, 6½ (which is the example of FIG. 2F), and/or other quantities in order to be classified as an erasure gesture.

FIG. 2G depicts another example of erasure finger gesture, in accordance with some example implementations. In this example, the erasure finger gesture 240 is depicted by the arrows showing back and forth finger movements over an area associated an entry to be canceled. For example, the finger may move to back and forth a plurality of times and in a plurality of directions.

To be detected as a valid erasure finger gesture in some implementations, the motion may be required to be within a given region. Referring to FIG. 1A, if April 15 is an entry to be canceled, then the erasure finger gesture may be required to be within the square region associated with the April 15 date on the calendar. If two days are to be canceled such as April 14^{th} and 15^{th}, the erasure gesture may be required to be within both squares associated with April 14^{th} and 15^{th}.

In some implementations, the computing device hosting the touchscreen may generate feedback, such as haptic feedback, an erasure sound, and/or the like to alert the user of the erasure and/or the cancellation of the entry.

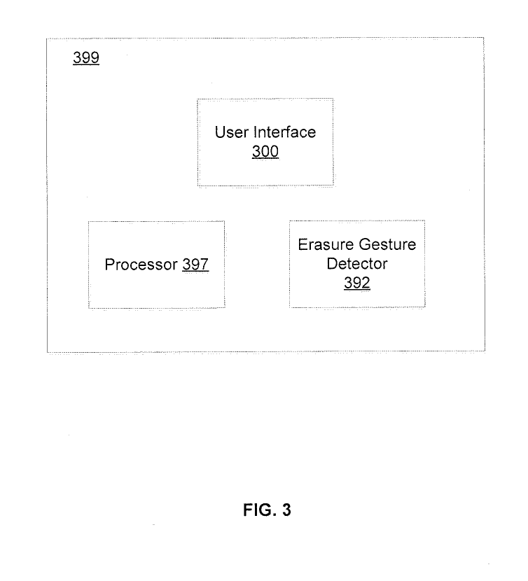

FIG. 3 depicts a system 399 for detecting erasure finger gestures, in accordance with some example implementations. The description of FIG. 3 also refers to FIGS. 2A-2G. System 399 may include a user interface 300, a processor 397, and an erasure gesture detector 392.

The user interface 300 may include a touchscreen upon which a graphical planner and/or other type application page (or view) may be presented, such as a planner page 100. The processor 497 may comprise at least one processor circuitry and at least one memory circuitry including computer code, which when executed may provide one or more of the functions disclosed herein. For example, the erasure gesture detector 392 may be implemented using processor 397, although erasure gesture detector 392 may be implemented using dedicated circuitry as well. To illustrate further, user interface 300 may include a touch sensitive user interface, such as a display, and some of the aspects of the erasure gesture detector 392 may be incorporated into the user interface 300.

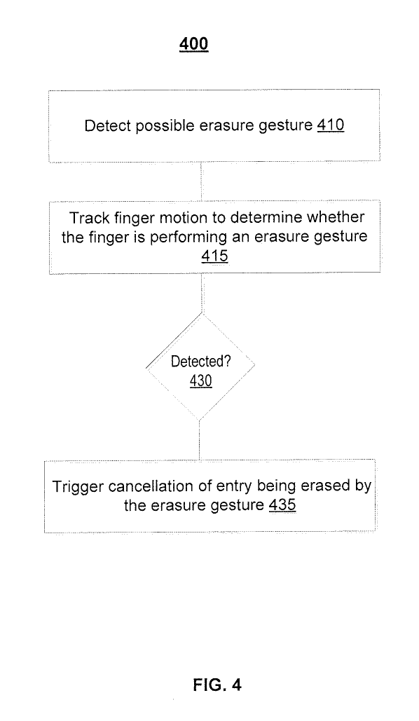

FIG. 4 depicts a process 400 for detecting erasure finger gestures, in accordance with some example implementations.

At 410, a possible erasure gesture may be detected. For example, when a user touches (or is proximate to) touchscreen user interface 300 presenting for example a graphically based planner or calendar 100, the erasure gesture detector 492 may detect this event. For example, a touchscreen may have a touch sensitive surface that can detect a touch. Moreover, the detected touch may be required to be over an area that can be canceled. Referring to FIG. 1B for example, the touch may be required to be over the area of April 15 (which in this example is a candidate for cancellation since it was selected) in order to be considered a valid initial touch for an erasure finger gesture.

At 415, erasure gesture detector 492 may track the figure touch at 410 to determine whether the gesture is an erasure finger gesture. For example, the erasure gesture detector 492 may determine whether the finger making contact with the touchscreen performs a back and forth motion over a portion of the planner that can be canceled. Referring again to FIG. 1B, the erasure gesture detector 492 may detect whether the finger is performing an erasure gesture (for example, a back and forth motion as described with respect to FIG. 1B and FIG. 2A-G) over a valid area, such as the April 15 date entry. When the erasure gesture is detected at 430, this may trigger, at 435, the erasure gesture detector 492 to send at a message to a planning application to cancel the entry being erased. The tracking may compare the detected figure touch on the surface (and the corresponding movement) to one or more patterns of the back and forth finger touch, so that if there is a match for example the erasure gesture may detected.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor, and may be implemented in a high-level procedural and/or object-oriented programming language, and/or in assembly/machine language. As used herein, the term “machine-readable medium” refers to any non-transitory computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

Although a few variations have been described in detail above, other modifications are possible. For example, while the descriptions of specific implementations of the current subject matter discuss analytic applications, the current subject matter is applicable to other types of software and data services access as well. Moreover, although the above description refers to specific products, other products may be used as well. In addition, the logic flows depicted in the accompanying figures and described herein do not require the particular order shown, or sequential order, to achieve desirable results. Other embodiments may be within the scope of the following claims.

What is claimed:

1. A system comprising:
at least one processor; and
at least one memory including program code which when executed causes operations comprising:
detecting a touch on an entry presented on a touchscreen as a candidate erasure figure gesture;
tracking a finger motion associated with the detected touch to determine whether the finger motion corresponds to an erasure figure gesture; and
sending a message to cancel the entry, when the finger motion corresponds to the erasure figure gesture.

2. The system of claim 1, wherein when the finger motion corresponds to a back and forth movement along the touchscreen, the finger gesture is determined to be the erasure figure gesture.

3. The system of claim 2, wherein the back and forth movement is over the same axis.

4. The system of claim 2, wherein the back and forth movement is over the same area.

5. The system of claim 2, wherein the back and forth movement is over substantially the same area and/or axis.

6. The system of claim 2, wherein the back and forth motion is predefined with respect to an initial direction.

7. The system of claim 6, wherein the initial direction is right, left, horizontal, vertical, or a combination thereof.

8. The system of claim 2, wherein the back and forth motion is predefined with respect to a quantity of back and forth movements.

9. The system of claim 8, wherein the quantity comprises 1½ back and forth movements.

10. The system of claim 8, wherein the quantity comprises at least one 2, 3, or 4 back and forth movements.

11. The system of claim 1, wherein the sending further comprises:
sending the message, when the finger gesture remains within a region on the touchscreen associated with the entry.

12. The system of claim 11, wherein the entry is at least a date on a planner.

13. A method comprising:
detecting a touch on an entry presented on a touchscreen as a candidate erasure figure gesture;
tracking a finger motion associated with the detected touch to determine whether the finger motion corresponds to an erasure figure gesture; and
sending a message to cancel the entry, when the finger motion corresponds to the erasure figure gesture.

14. The method of claim 13, wherein when the finger motion corresponds to a back and forth movement along the touchscreen, the finger gesture is determined to be the erasure figure gesture.

15. The method of claim 14, wherein the sending further comprises:
sending the message, when the finger gesture remains within a region on the touchscreen associated with the entry.

16. A non-transitory computer-readable medium including program code which when executed by at least one processor causes operations comprising:
detecting a touch on an entry presented on a touchscreen as a candidate erasure figure gesture;
tracking a finger motion associated with the detected touch to determine whether the finger motion corresponds to an erasure figure gesture; and
sending a message to cancel the entry, when the finger motion corresponds to the erasure figure gesture.

17. The non-transitory computer-readable medium of claim 16, wherein when the finger motion corresponds to a back and forth movement along the touchscreen, the finger gesture is determined to be the erasure figure gesture.

18. The non-transitory computer-readable medium of claim 16, wherein the sending further comprises:
sending the message, when the finger gesture remains within a region on the touchscreen associated with the entry.
